(19) United States
(12) Patent Application Publication
(10) Pub. No.: US 2026/0265050 A1
(43) Pub. Date: Sep. 10, 2026

(54) METHOD FOR CONVERTING ORTHOHYDROGEN TO PARAHYDROGEN

(71) Applicant: C&CS CATALYSTS AND CHEMICAL SPECIALTIES GMBH, Kirchheim bei München (DE)

(72) Inventors: Hans-Jürgen EBERLE, München (DE); Arno TISSLER, Tegernheim (DE)

(21) Appl. No.: 18/880,177

(22) PCT Filed: Jun. 29, 2023
(86) PCT No.: PCT/EP2023/067887

§ 371 Date: Dec. 30, 2024

(30) Foreign Application Priority Data
Jun. 30, 2022 (DE) 102022002380.6
Jun. 30, 2022 (DE) 102022002381.4

(51) Int. Cl. C01B 3/0089; B01J 29/072; B01J 37/00; B01J 37/02

(52) U.S. Cl. CPC C01B 3/0089; B01J 29/072; B01J 37/0063; B01J 37/0215; B01J 2523/842; C01B 2203/1023; C01B 2203/1047

(57) ABSTRACT

The subject-matter of the invention is a new process for the conversion of ortho-to para-hydrogen. The present invention also relates to the use of an iron-containing zeolite, preferably according to a process as described herein, for conversion of hydrogen allotropes.

The present invention primarily relates to a process for conversion of ortho-hydrogen to para hydrogen, characterized in that an iron-containing zeolite is used as catalyst. The present invention also relates to a use of an iron-containing zeolite for conversion of hydrogen allotropes, preferably as further described herein.

Further aspects of the present invention and preferred embodiments thereof will become apparent from the following description and the attached claims.

The production of energy and chemical products from natural resources such as petroleum or natural gas will no longer be viable in medium term due to limited reserves. In particular, this use results in high CO₂ emissions, which lead to global warming. Although, at present, the possible consequences of this can only be estimated, it is foreseeable that this will become a question of survival for humanity. Furthermore, oil is far too valuable for the chemical industry to be burned due to its composition and the large number of basic molecules. Alternatives to fossil fuels are of utmost importance for the long-term success of an energy transition and for global climate protection.

Hydrogen will play a key role here, whether as an energy store or as a material component for further material transformations. Climate-friendly hydrogen production (=green hydrogen) makes it possible to reduce CO₂ emissions in mobile and stationary applications. This applies in particular to applications in which the direct use of electricity from renewable sources is insufficient or not possible. The production of hydrogen from renewable resources, its transportation and storage are therefore key issues at a global level.

For the storage and transportation of hydrogen, liquification and subsequent storage in liquid form is often the most economical solution due to the significantly increased density. This is especially true when the geographical distance between the production site and the point of consumption is very large. Efficient transportation in pipelines would require extremely high pressure, which under these conditions would cause the metal pipes to become brittle. In addition, numerous high-pressure compressors would be needed, which would ultimately make transportation uneconomical due to their high energy requirements. Therefore, hydrogen pipelines are only used on a local scale, within chemical sites or network sites.

The hydrogen molecule can exist in two variants (allotropy), which differ in the orientation of their ¹H nuclear spin, thus exhibiting different rotational energies, which in turn lead to different physical properties. In the para form, the two nuclear spins are orientated anti-parallel, in the ortho form they are parallel. The allotropy of hydrogen was discovered in the 1920s as part of the development of quantum theory. The names associated with this are, for example, Bonhoeffer, Heisenberg, Eucken, Mecke and Hund (U. Schindewolf, Bunsen-Magazin, 4th year, 6/2002, pp. 139-146).

The two allotropes coexist in a temperature-dependent equilibrium: above 250 K, the hydrogen allotropes mixture consists of 75% of the ortho form and 25% of the para form. A further increase in the ambient temperature does not change this ratio. In this case, we speak of normal hydrogen. At low temperatures, as required for the liquification of hydrogen, the equilibrium shifts more and more towards the para form. At temperatures below 20 K, almost only the para form is present (DE 4403352B4 ). However, the equilibrium conversion from the ortho to the para form occurs only slowly during cooling because the interactions between the nuclei are very weak. The conversion of ortho hydrogen to the para form is exothermic with a conversion energy of 527 KJ/kg. Conversely, the conversion from the para form to the ortho form is an exergonic reaction.

The rate of the ortho-para conversion and the exothermicity of the reaction play an important role in the liquification of hydrogen. On the one hand, the energy required for liquification is necessarily increased because the released energy (527 kJ/kg) is higher than the vaporization enthalpy of para-hydrogen (44 6 kJ/kg), i.e. with increasing ortho-to-para conversion hydrogen evaporates and/or one must continue to cool with a high energy input so that the entire quantity remains liquid. On the other hand, due to the slow equilibration, a certain proportion of the ortho-hydrogen is not converted to para-hydrogen. During subsequent storage, the energy released during the self-conversion would cause evaporation and thus an undesirable loss of liquid hydrogen. For commercial liquid hydrogen, a para-hydrogen content of at least 95% is therefore required, which ultimately significantly minimizes possible evaporation losses (storage time 14 days, hydrogen loss<1%).

In order to achieve the required low ortho-hydrogen content, all industrial hydrogen liquification plants use catalysts that accelerate the equilibration process during the cooling process. If the establishment of the respective equilibrium is as fast as the cooling rate, no further energy is released at the triple point. In practice, a catalyst based on paramagnetic iron oxide (Fe₂O₃, IONEX® Type O-P Catalyst, Molecular Products) is used almost exclusively for this purpose. Thereby, already at present, a significant energy saving can be achieved (approx. 20%).

Catalytic conversion through the interaction of the hydrogen molecule with a paramagnetic surface/species was discovered as early as the beginning of the 1930s by Farkas and Sachse (Farkas, A.; Sachse, H., \ddot{U}ber die homogene Katalyse der para-ortho-Wasserstoff-umwandlung unter Einwirkung paramagnetischer lonen II; Z. Physik. Chem. B23 (1933), pp. 19-27 25). Although other paramagnetic catalysts have been described, such as Ru/silicate, Ru/aluminate (U.S. Pat. No. 9,714,168 B1), Cr₂O₃ on Al₂O₃, CeO₂, Ni/Al₂O₃, MnO₂ on Al₂O₃ and unsupported (D. H. Weitzel, W. V. Loebenstein, J. W. Draper and O. E. Park, J. Of Research of National Bureau of Standards, Vol. 60, Nr. 3, 1958), Oxysorb®, a CrO₃ on SiO₂ and Apachi Nickel-Silica from Air Products (Jürgen Essler, Dissertation: Physikalische und technische Aspekte der Ortho-Para-Umwandlung (2012), Chapter 5.5.3, p. 67 ﬀ, Technical University of Dresden). All candidates examined so far were less effective than the standard iron oxide catalyst.

However, the iron oxide catalyst commonly used today still has a number of disadvantages. The catalyst grains used are in the range of 0.3 to 0.6 mm and are very brittle. This means that they develop small particles (dust), which can lead to process difficulties. The available surface is essentially the geometric surface of the particles, i.e. the centers within the catalyst grain are not accessible to hydrogen. Furthermore, the material is highly hygroscopic, which hinders the conversion even at low water concentrations and/or makes complex activation and regeneration necessary, i.e. negatively influences the lifetime of the catalyst. It should also be mentioned that the crystalline form, like the grain sizes, severely restricts an optimized design for the application process (e.g. cooling process).

It should also be mentioned that the known iron oxide catalysts can only be used in the ortho-para conversion process from 80 K and below, i.e. they cannot yet be used in the previous cooling process at higher temperatures. This is mainly because the known catalysts are hygroscopic and the initial mixture must be freed from water residues beforehand via the cooling process.

For potentially suitable catalysts, a number of physical parameters must be considered and optimized in order to achieve an optimal overall effect. These are, in particular,
1. diffusion through the flow boundary layer to the catalyst surface,
2. diffusion into the pores of the catalyst,
3. adsorption on the surface of the catalyst center,
4. surface reaction or interaction with paramagnetic centers or, if applicable, with hydrogen exchange centers
5. desorption from the surface of the catalyst center,
6. diffusion of the products out of the pores and
7. diffusion of the products through the flow boundary layer.

An effective catalyst is one in which the entire process occurs at the desired speed. The slowest step in this process chain thus determines the overall speed of the desired reaction. The conversion rate can be analyzed by various methods. The method described by Linde A G in DE 4403352 B4 can be mentioned here as standard. In this method, physical data such as temperature and pressure are measured before the conversion (before the catalyst) and after the conversion (after the catalyst) and the para-to-ortho ratio is calculated using the known physical data. This method is described in detail in DE 4403352B4 .

The primary object of the present invention is to provide a process for conversion of ortho-to para-hydrogen that overcomes the disadvantages described above. Preferably, a process shall be provided that, on the one hand, avoids or reduces hydrogen losses by evaporation during the production of liquid hydrogen and, on the other hand, minimizes or reduces the ratio of ortho-hydrogen, preferably in such a way that the adjustment of the thermodynamic ortho-para hydrogen equilibrium is aligned with that of the cooling rate during the entire cooling process. This should advantageously lead to energy savings in the cooling process and generally to cost savings as well. Furthermore, the present invention should preferably result in a higher-quality commercially liquidified hydrogen that meets the requirements of having a para-hydrogen content of at least 95%. In addition, a process shall be provided in which such a favorable catalyst is used that elaborate activation and regeneration treatments of the catalyst are not necessary, with little or no loss of efficiency. Above all, a process shall be provided in which the catalyst can be used in a significantly wider temperature range than the previously known iron oxide catalysts. Further objects underlying the present invention will be apparent from the following description and the attached claims.

Surprisingly, it was found in the context of the present invention that iron-doped hydrophobic zeolites, which advantageously have Broenstedt centers, are ideally suited for the conversion of ortho-to para-hydrogen. Silicon-rich zeolites, which have hydrophobic properties, a high internal surface area of several hundred m²/g and proton-Broenstedt centers, have proven to be particularly suitable. Since iron species or clusters are geometrically limited in their growth by a preferably small pore size of 4 to 8 angstroms in the zeolites, such catalysts exhibit a high intrinsic center utilization. The accessibility is ideally provided by the multi-dimensional pore system, e.g. in zeolites of the MFI, MOR, FAU or BEA-type (three-dimensional pore system). The additionally advantageously present Proton-Broenstedt centers are capable of proton exchange with hydrogen and thereby additionally accelerate (catalyze) the overall conversion to para-hydrogen in higher ranges of the process temperature.

The present invention relates, according to a primary aspect, to a process for conversion of ortho-hydrogen to para-hydrogen, comprising or consisting of the following steps:
providing a starting mixture of or comprising of ortho-and para-hydrogen,
cooling the starting mixture and converting ortho-hydrogen to para-hydrogen by use of a catalyst,
characterized in that an iron-containing zeolite is used as catalyst.

A preferred embodiment is a process according to the invention as described herein, characterized in that the cooling of the starting mixture and conversion of ortho-hydrogen to para-hydrogen is carried out according to one of the following steps:
a) cooling the starting mixture and then converting ortho-hydrogen to para-hydrogen by use of the catalyst, or
b) simultaneously or partially simultaneously cooling the starting mixture and converting ortho-hydrogen to para-hydrogen by use of the catalyst, or
c) cooling the starting mixture and then reacting ortho-hydrogen to para-hydrogen by use of the catalyst, whereby during the conversion the starting mixture is cooled further.

In a particularly preferred embodiment, a process according to the invention is characterized in that a liquid or cryogenic hydrogen with a para-hydrogen content of at least 95 wt.-%, based on the total hydrogen content, is produced.

Another preferred embodiment is a process according to the invention as described above, characterized in that the iron-containing zeolite has Broenstedt centers.

A catalyst particularly suitable for the process described herein should have a high con-centration of paramagnetic centers, or rather a high concentration of potential H⁺ exchange centers, a high tendency to adsorb hydrogen, and high accessibility (porosity) to minimize diffusion barriers. The materials described and examined in the literature are mostly hydrophilic and do not have acidic proton Broenstedt centers.

In a particularly preferred embodiment, the iron species in the zeolite pores and/or pore intersections have a maximum diameter of 12 Angstroem or less.

Another preferred embodiment of a process according to the invention is wherein the iron-containing zeolite has one of the following structures: MFI, BEA, MOR, CHA, AEI, AFX, FAU.

Another preferred embodiment of the invention is a process wherein the used iron-containing zeolite has a molar SiO₂/Al₂O₃ ratio between 2 and 1000, preferably between 5 and 200, particularly preferably between 10 and 100.

According to a preferred embodiment, the molar SiO₂/Al₂O₃ ratio of the iron-containing zeolite is adjusted or set such that it is hydrophobic.

Another preferred embodiment is a process according to the invention, wherein the iron-containing zeolite has an atomic Fe/Al ratio between 0.1 and 2, preferably between 0.2 and 1.

Another preferred embodiment is a process according to the invention, wherein the catalyst is present as a shaped body.

In this case, it is preferred that the shaped body has a regular or irregular geometric shape, preferably one or more shapes selected from the group consisting of a sphere, pellet, full cylinder, such as extruded pellets or tablets, hollow cylinders such as rings, cylindrical body with several through-going internal drillings, trilopes, crown rings, wheels, armchairs, gran-ules, fragments of compacted masses, monoliths and cross-channel structures.

Another preferred embodiment is a process according to the invention, wherein the shaped body (preferably as described above) is produced by extrusion, granulation, tableting or compacting.

Another preferred embodiment is a process according to the invention, wherein the catalyst is/has been produced by coating a honeycomb or another geometric shaped body.

Another aspect of the present invention relates to the use of an iron-containing zeolite (as described in the context of the process herein according to the invention) for conversion of hydrogen allotropes, preferably from ortho-to para-hydrogen, preferably in a process as described herein, particularly preferably in a preferred embodiment thereof (as described herein).

Also described herein is the product of a conversion of ortho-to para-hydrogen, obtained or obtainable according to a process described herein, preferably as described herein as preferred, the product preferably having a para-hydrogen content of at least 95%, based on the total amount of hydrogen.

Another preferred embodiment of a process according to the invention is a process as described above, wherein the temperature of conversion is in a range of from 150 to 20 K, preferably in a range of from 120 to 20 K, most preferably in a range of from 80 to 20 K.

A further preferred embodiment is a process according to the invention as described herein, wherein the pressure during conversion is in a range from 50 to 5 bar, preferably in a range from 30 to 13 bar.

A preferred embodiment is a process according to the invention as described herein, wherein the iron-containing zeolite has pore openings with an average diameter in the range of from 4 to 8 Angstroms.

Also disclosed herein is an iron-containing zeolite catalyst for the conversion of ortho-hydrogen to para-hydrogen, characterized in that the iron-containing zeolite has pore openings with an average diameter in the range of from 4 to 8 Angstroms. In all other respects, the catalyst is as defined above for the catalyst to be used according to the invention and its preferred embodiments, or as specified in the attached claims.

For example, it is therefore preferred that such an iron-containing zeolite catalyst is characterized in that the zeolite has Broenstedt centers.

For example, it is further preferred that an iron-containing zeolite catalyst is characterized in that the zeolite has one of the following structures: MFI, BEA, MOR, CHA, AEI, AFX, FAU.

Further, preferably an iron-containing zeolite catalyst is characterized in that the SiO₂/Al₂O₃ molar ratio is between 2 and 1000, preferably between 5 and 200, more preferably between 10 and 100.

For example, it is also preferred that an iron-containing zeolite catalyst is characterized in that an Fe/Al ratio between 0.1 and 2 is present, preferably between 0.2 and 1.

Furthermore, it is particularly preferred that an iron-containing zeolite catalyst is characterized in that the catalyst is present as a shaped body.

In addition, it is particularly preferred that an iron-containing zeolite catalyst is characterized in that the shaped body is prepared by extrusion, granulation, tableting or compacting.

It is particularly preferred that an iron-containing zeolite catalyst is characterized in that the catalyst is/has been prepared by coating a honeycomb or another geometric shaped body. Furthermore, it is generally preferred in connection with the catalysts described herein that the catalyst is obtained or obtainable by iron exchange by means of solid-state ion ex-change.

Furthermore, the preferred size of the iron species is generally in the range of 2 to 100 iron atoms and particularly preferred in the range of 2 to 20 iron atoms. The iron clusters can be detected using known methods and thus a catalyst modification can be controlled for the respective intended applications (see, for example, Sando Brandenberger, Oliver Kröcher, Arno Tissler and Roderik Althoff “State of the Art in Selective Catalytic Reduction of NOₓ by Ammonia Using Metal-Exchanged Zeolite Catalysts” in Catalysis Reviews, Vol. 50 (2008) pp. 492-531). The method with UV-VIS, as described in the cited literature, is particularly suitable.

The invention will be explained in more detail below with reference to selected examples. The examples do not represent any restrictions in the sense of the present invention. The invention can include any embodiment that is familiar to a skilled person in the art.

### DESCRIPTION OF THE FIGURES

FIG. 1 shows a simplified model of a measuring cell for determining the temperature change during an adiabatic conversion.

FIG. 2 shows an illustration of the operating principle of the measurement of the ortho-and para-hydrogen proportions over the temperature difference during the adiabatic conversion.

### EXAMPLES

### 1) Preparation of an Iron-Containing Zeolite Catalyst

Example 1: A commercially available faujasite zeolite (zeolite Y) in the ammonium form with a SiO₂/Al₂O₃ ratio of 12 was treated with an aqueous iron (II) sulfate solution according to a liquid-phase ion exchange. For this purpose, 140 g Fe(II)SO₄×7 H₂ O (Roth company) were dissolved in 5 liters of distilled water at 80° C. in a 10-liter container equipped with a stirrer and a heating rod. Afterwards, 1 kg of the ammonium zeolite was added and stirred for an hour. The pH value was 3.6. The mixture was then filtered off and the resulting moist powder was predried at 120° C. in a flat bed and then tempered in a oven at 500° C. for 6 hours. The result was 1020 g of Fe zeolite in powder form. The average degree of ex-change, calculated from the quantities used and defined as Fe/Al, was 0.5, which corresponds to a weight proportion of Fe₂O3 in the exchanged zeolite of approx. 8 wt. %.

Example 2: A commercially available zeolite of the faujasite type in the ammonium form with an SiO₂/Al₂O₃ ratio of 12 was treated with Fe(II)Cl₂×4 H₂0 using a solid-state ion exchange method. To do this, 100 g of the ammonium zeolite was mixed with 10 g of iron (II) chloride×4 H₂ O (Merck) in a laboratory mortar and then ground for 15 minutes. The powder obtained was then tempered in a laboratory oven at 500° C. for 12 hours. The resulting powder quantity was 105 g. The average degree of exchange calculated from the quantities used, defined as Fe/Al, was 0.5, which corresponds to a weight proportion of Fe₂O₃ in the exchanged zeolite of approx. 8 wt. %.

Example 3: A commercially available zeolite of the BEA type (zeolite beta) in the ammonium form with an SiO₂/Al₂O₃ ratio of 10 was treated with an aqueous iron (II) SO₄ solution according to a liquid-phase ion exchange. The procedure was analogous to the conditions described in example 1, with the difference that 1 kg of the ammonium zeolite (BEA type) and 158 g of Fe(II)SO₄×7 H₂ O (Roth company) were used. The mean degree of exchange, calculated from the quantities used and defined as Fe/Al, was 0.5, which corresponds to a weight proportion of Fe₂O₃ in the exchanged zeolite of approx. 9 wt. %. The resulting powder quantity was 1020 g.

Example 4: A commercially available zeolite of the BEA type (zeolite beta) in the ammonium form with an SiO₂/Al₂O₃ ratio of 10 was treated with Fe(II)Cl₂×4 H₂0 using a solid-state ion exchange process. The procedure was analogous to the conditions described under example 2, with the difference that 100 g of the ammonium zeolite (BEA type) and 11 g of iron(II) chloride×4 H₂O were used. The result was 105 g Fe-zeolite with a calculated mean degree of exchange, defined as an Fe/Al ratio of 0.5, which corresponds to a weight proportion of Fe₂O3 in the exchanged zeolite of approximately 9 wt. %.

### 2) Forming the Catalyst Masses Into Technically Usable Catalysts

Example 5: The obtained and dried iron-zeolite powders of examples 1 to 4, with an average particle size of less than 20 μm and a residual moisture content of less than 10% by weight were filled into a press mold with a diameter of approx. 7.5 cm and subjected to a punch pressure of 90 bar for 1 minute. After removal from the mold, the resulting pellet was placed on the upper sieve of a two-stage sieving combination, with the first sieve having a mesh size of 700 μm and the second sieve, arranged below it, having a mesh size of 500 μm, and crushed with the help of a mortar. The proportion of the sieve fraction obtained of 500-700 μm was in each case 55-60 wt.-% of the original pellet. All the shaped catalyst samples produced in this way showed no dust formation in filling tests and are technically usable with regard to shape stability. The example shows that the shaping, such as tablet-ting or compacting, can be carried out, whereby the shaping of the catalyst compositions according to the invention can also be carried out without processing aids and thus a possible disturbance of the catalytic activity can be avoided.

Example 6: A suspension was prepared from 1 kg iron zeolite powder (iron zeolite type BEA, produced via solid ion exchange), prepared according to the process described in example 4, 2.3 L deionized water and 120 g Ludox 40 (SiO₂-Sol from the company Grace) using an intensive stirrer. The solids content of the suspension (washcoat) was 29.0 wt.-%. This washcoat was used to coat a cordierite ceramic honeycomb substrate with a cell density of 200 cpsi (cells per square inch) and dimensions of 10 cm×10 cm×10 cm using a conventional coating process known to those skilled in the art (dipping and subsequent blowing out of the excess washcoat with air). The coated honeycomb was then dried in a circulating air drying cabinet (T=130° C., duration 5 h) and then calcined at 500° C. for 3 h. The application rate of iron zeolite powder was 130 g/l honeycomb.

The example shows that geometrically structured objects or carrier materials can be converted into ortho-para hydrogen rearrangement catalysts by coating techniques, while maintaining the geometry of the carrier.

### 3) Ortho-Para Hydrogen Conversion: Measuring the Catalytic Property

To measure the catalytic effect of catalysts in ortho-para hydrogen conversion, a standard method as described in DE 4403352 is used. The basic principle of the method is based on the measurement of the enthalpy difference occurring during the exothermic ortho-para conversion in the form of the temperature change of a defined (pressure/temperature) ortho-para H₂ mixture in the presence of a catalyst under adiabatic conditions and the degree of conversion resulting from calculation.

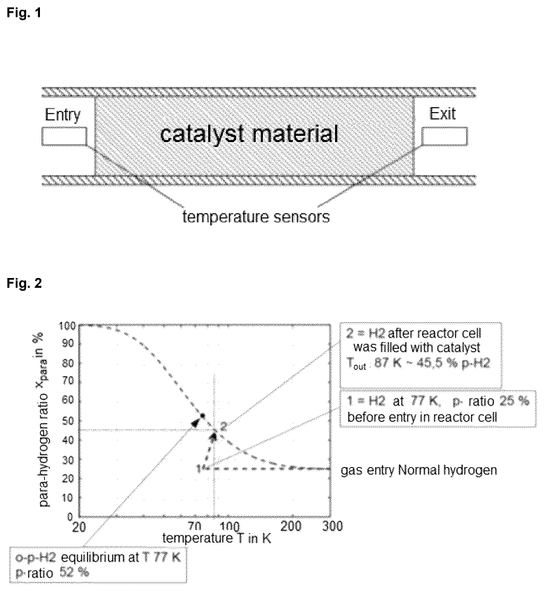

For the operating principle, see FIG. 1 and FIG. 2 as examples.

Advantageous measurement conditions/steps are:
Catalyst: approx. 7 cm³ , grain size 500-700 μm.
Activation/drying: approx. 160° C., with dried N₂, H₂ or He at T approx. 160° C.
Reaction: starting material normal hydrogen dry, P approx. 3.5 bar, Tᵢₙ: 77 K, corresponding to liquid N₂.
T measurement after reactor, measurement duration until Tₒᵤₜ=constant, approx. 30-60 min.
Mass flow H₂: after reactor or measuring apparatus, at room temperature by means of volume flow measurement.

Further settings can be made, e.g. other volume flows to obtain a more accurate picture of the catalyst efficiency by changing the ratio of the mass fraction of catalyst to gas volume.

In terms of catalytic activity in the o-p conversion, the iron zeolites produced in examples 1-4 can be arranged in the following order:

BEA-10 (solid state exchange; corresponds to example 4)>FAU-12 (solid state exchange; corresponds to example 2)>BEA-10 (liquid state exchange; corresponds to example 3)>FAU-12 (liquid state exchange; corresponds to example 1).

1. Process for conversion of ortho-hydrogen to para-hydrogen, comprising or consisting of the following steps:
providing a starting mixture of or comprising of ortho-and para-hydrogen,
cooling the starting mixture and converting ortho-hydrogen to para-hydrogen by use of a catalyst,
characterized in that an iron-containing zeolite is used as catalyst.

2. Process according to claim 1, characterized in that the iron-containing zeolite has Broenstedt centers.

3. Process according to claim 1 or 2, wherein the iron species in the zeolite pores and/or pore intersections have a maximum diameter of 12 Angstroms or less.

4. Process according to any one of claims 1 to 3, characterized in that the iron-containing zeolite has one of the following structures: MFI, BEA, MOR, CHA, AEI, AFX, FAU.

5. Process according to any one of claims 1 to 4, characterized in that the used iron-containing zeolite has a molar SiO₂/Al₂O₃ ratio between 2 and 1000, preferably between 5 and 200, particularly preferably between 10 and 100.

6. Process according to any one of claims 1 to 5, characterized in that the iron-containing zeolite has an atomic Fe/Al ratio between 0.1 and 2, preferably between 0.2 and 1.

7. Process according to any one of claims 1 to 6, characterized in that the catalyst is present as a shaped body.

8. Process according to any one of claims 1 to 7, characterized in that the shaped body is prepared by extrusion, granulation, tableting or compacting.

9. Process according to any one of claims 1 to 8, characterized in that the catalyst is/has been prepared by coating a honeycomb or another geometric shaped body.

10. Use of an iron-containing zeolite as defined in any one of claims 1 to 9 for conversion of hydrogen allotropes, preferably from ortho-to para-hydrogen, preferably in a process according to any one of claims 1 to 9.
